(19) United States
(12) Patent Application Publication
(10) Pub. No.: US 2012/0055723 A1
(43) Pub. Date: Mar. 8, 2012

(54) Heating system for an automotive vehicle

(76) Inventor: Jose de Paula Moreira, Worcester, MA (US)

(21) Appl. No.: 13/135,647

(22) Filed: Jul. 12, 2011

Related U.S. Application Data
(60) Provisional application No. 61/399,458, filed on Jul. 12, 2010.

(51) Int. Cl. B60K 11/04; B60H 1/02

(52) U.S. Cl. 180/68.4; 237/12.3 R

(57) ABSTRACT

An automotive vehicle includes a frame shaped to define an interior cabin, an engine for powering the vehicle, the engine utilizing a liquid coolant to absorb and transfer excess heat produced therefrom, and a heating system for transferring heated coolant away from the engine. The heating system comprises a primary heating device coupled to the frame for radiantly warming the interior cabin, a secondary heating device disposed within the vehicle dashboard for blowing warm air into the interior cabin, and an exterior heating device coupled to the frame for radiantly warming the immediate exterior of the automotive vehicle. The primary heating system utilizes an elongated length of conductive piping that circulates heated coolant along the ceiling panel of the frame so that heat is radiantly dispensed into the interior vehicle cabin in a uniform pattern of distribution. A porous and heat-resistant fabric layer is fastened to the frame to enclose the conductive piping.

### CROSS-REFERENCE TO RELATED APPLICATIONS

The present application claims the benefit of U.S. Provisional Patent Application Ser. No. 61/399,458, which was filed on Jul. 12, 2010 in the name of Jose de Paula Moreira, the disclosure of which is incorporated herein by reference.

### BACKGROUND

The present invention relates generally to automotive vehicles and more particularly to heating systems for automotive vehicles.

The engine for an automotive vehicle produces an excessive amount of heat during normal operation. Without adequate treatment, this excessive production of heat would ordinarily destroy the engine. Accordingly, every automotive vehicle is typically provided with some form of a cooling system to remove excess heat generated by its engine.

The vehicle cooling system releases some of the excess heat produced by the engine through the vehicle exhaust system. The remaining excess heat is absorbed by a liquid coolant (e.g., a mixture of water and antifreeze) that circulates through the vehicle. Specifically, coolant that is heated by the engine is transferred to a radiator by hoses. The radiator then releases heat in the coolant to the air outside of the vehicle through a convection process. As the temperature of the coolant is reduced, it is returned to the engine, once again, to absorb excess heat, thereby creating a continuous heat-transfer cycle.

As can be appreciated, coolant heated by the engine is also commonly used to warm the interior passenger cabin of an automotive vehicle. Specifically, a heater core is mounted in the vehicle dashboard. The heater core is similar in construction to a radiator in that it includes one or more metal pipes adapted to receive the coolant, each pipe having a plurality of outwardly extending conductive fins mounted thereon. In use, coolant heated by the engine is passed to the heater core which, in turn, warms the plurality of fins. A fan is positioned to blow directly through the plurality of warmed fins to produce a stream of warmed air that is, in turn, directed into the interior vehicle cabin through heating vents provided in the vehicle dashboard.

Vehicle heating systems that rely upon the combination of a heater core and a dashboard fan suffer from a couple notable shortcomings.

As a first drawback, heating systems of the type as described above blow hot air directly into the face and/or legs of the front passengers. As a result, it has been found that the heated air is unevenly distributed throughout the interior cabin, which is highly undesirable.

As a second drawback, heating systems of the type as described above generate heated air that has been found to be inadequately warmed (i.e., a cooler heat). As a result, it has been found that the air within the interior cabin is often incapable of reaching a comfortable temperature, which is highly undesirable.

### SUMMARY OF THE INVENTION

It is an object of the present invention to provide a new and improved system for heating the interior cabin of an automotive vehicle.

It is another object of the present invention to provide a system as described above that distributes heat evenly within the interior vehicle cabin.

It is yet another object of the present invention to provide a system as described above that adequately and efficiently warms the interior vehicle cabin.

It is still another object of the present invention to provide a system of the type as described above which includes a limited number of parts, which is easy to use and which is inexpensive to manufacture.

Accordingly, there is provided a heating system for an automotive vehicle, the vehicle comprising a frame shaped to define an interior cabin, the vehicle additionally comprising an engine that utilizes a liquid coolant to absorb and transfer excess heat produced therefrom, the heating system comprising (a) a length of piping secured to the frame of the vehicle, and (b) a pair of transport tubes in fluid communication with both the length of piping and the engine, (c) wherein liquid coolant heated by the engine is transferred away from the engine through one of the transport tubes and circulates within the length of piping to radiantly warm the interior cabin of the automotive vehicle, the other of the transport tubes returning the radiantly cooled liquid coolant circulating within the length of piping back to the engine for reuse.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate an embodiment of the present invention and, together with the description, serve to explain the principles of the invention. In the drawings, wherein like reference numerals represent like parts:

FIG. 1 is a simplified schematic of an automotive vehicle equipped with a heating system constructed according to the teachings of the present invention;

FIG. 2 is a fragmentary section view of the automotive vehicle shown in FIG. 1, taken along lines 2-2;

FIG. 3 is a fragmentary bottom view, broken away in part, of the roof of the automotive vehicle shown in FIG. 1;

FIG. 4 is a fragmentary, front view, broken away in part, of the automotive vehicle shown in FIG. 1;

FIG. 5 is a fragmentary, front view, broken away in part, of the automotive vehicle shown in FIG. 1;

FIG. 6 is a fragmentary front view of the pair of ball valves used to regulate the flow of coolant through the heating system shown in FIG. 1; and

FIG. 7 is a fragmentary front view of the pair of tee pipes used to direct the flow of coolant through the heating system shown in FIG. 1.

### DETAILED DESCRIPTION

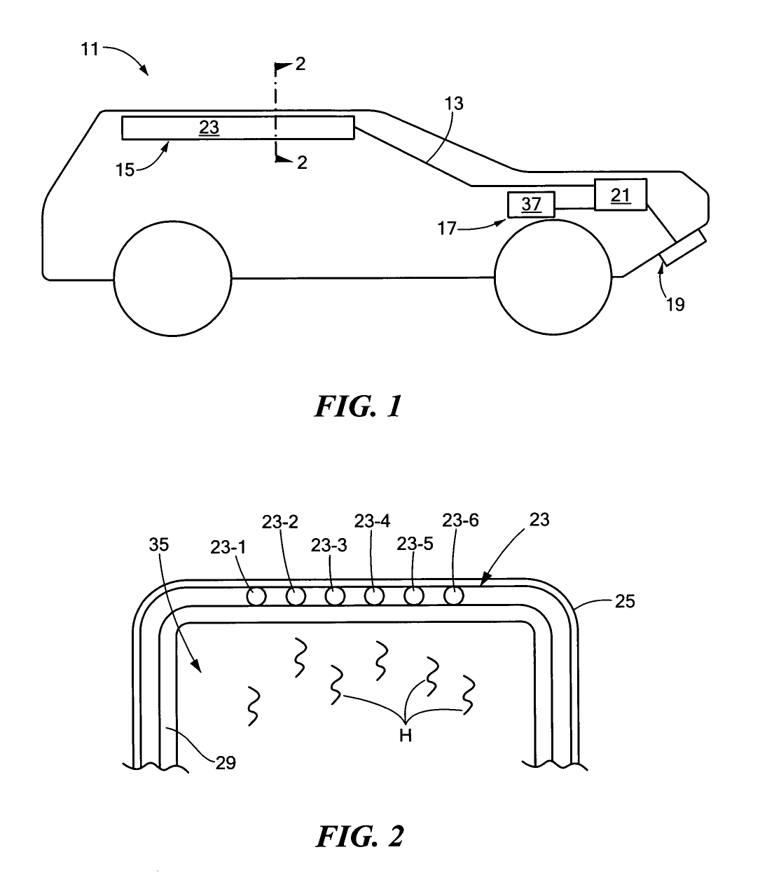

Referring now to FIG. 1, there is shown a simplified block diagram of an automotive vehicle 11 that is equipped with a novel heating system, the novel heating system being constructed according to the teachings of the present invention and identified generally by reference numeral 13. As will be described in detail below, heating system 13 includes three separate heating devices that are used to warm the interior and immediate exterior of vehicle 11. Specifically, heating system 13 comprises (i) a primary interior heating device 15 mounted in the ceiling of the interior cabin, (ii) a secondary interior heating device 17 mounted in the vehicle dashboard, and (iii) an exterior heating device 19 mounted on, or in close proximity to, the front vehicle bumper. All of the aforementioned heating devices utilize a common liquid coolant (e.g., a mixture of water and antifreeze) in fluid communication with the vehicle engine 21 that absorbs excess heat generated therefrom, as will be explained further below.

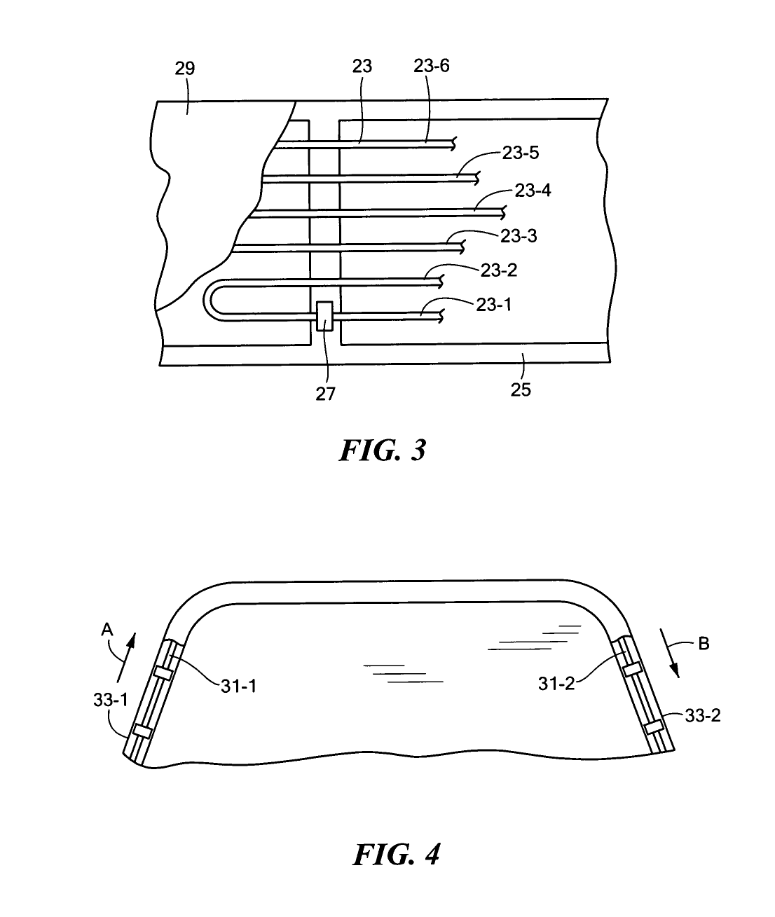

Referring now to FIGS. 1-3, primary interior heating device 15 preferably includes a length of continuous tubing, or piping, 23 that is constructed out of a rigid, durable and conductive material, such as fiberglass, metal or the like. As seen most clearly in FIGS. 2 and 3, tubing 23 is preferably arranged in a snake-like configuration that includes a plurality of straight parallel sections 23-1 thru 23-6 that are evenly spaced approximately 6 inches apart from one another. Length of continuous tubing 23 is preferably held fixed in place against the underside of the metal ceiling panel, or frame, 25 for vehicle 11 by aluminum tape 27 or other similar adhesive element (e.g., silicone). With tubing 23 mounted as such, a porous and heat resistant fabric layer 29 is secured to frame 25 by fasteners (not shown) over the length of tubing 23 to provide an aesthetically pleasing interior environment, fabric layer 29 preferably being both (i) porous to allow for the passage of radiant heat H therethrough and (ii) heat resistant for safety measures.

As seen most clearly in FIG. 4, coolant is circulated between ceiling mounted piping 23 and engine 21 by a pair of fluid transport tubes 31-1 and 31-2 that are fixedly mounted in opposite windshield pillars 33-1 and 33-2, respectively, of vehicle frame 25 by any suitable adhesive element, such as aluminum tape. Specifically, one fluid transport tube 33-1 serves as a feed tube for supplying ceiling mounted piping 23 with coolant heated by engine 21 (as represented by arrow A in FIG. 4). The other fluid transport tube 33-2 serves as a discharge tube for returning coolant circulated through piping 23 back to engine 21 for reuse (as represented by arrow B in FIG. 4).

Accordingly, in use, coolant heated by engine 21 is transported to ceiling mounted piping 23 via transport tube 31-1. As the heated coolant circulates through the length of piping 23, the heat in the coolant warms conductive piping 23 which, in turn, is radiantly dispensed into the vehicle cabin 35 through fabric layer 29, as represented by radiant heat H in FIG. 2. As can be appreciated, because continuous piping 23 extends broadly across the vehicle ceiling frame 25, the warm heat H produced therefrom is radiantly dispensed into interior vehicle cabin 35 in a uniform pattern of distribution and circulation, which is a principal object of the present invention.

It should be noted that piping 23 need not be limited to mounting on the ceiling panel of vehicle frame 25. Rather, it is to be understood that piping 23 could be alternatively located on other vehicle panels (e.g., the flooring panel) of frame 25 without departing from the spirit of the present invention.

It should also be noted that additional means may be provided to enhance circulation of heated air H within interior cabin 35. For example, a fan (not shown) may be provided to force warm air down from the ceiling panel and thereby promote greater circulation within interior cabin 35.

Referring back to FIG. 1, secondary interior heating device 17 is similar to traditional vehicle heating means in that device 17 preferably comprises a heater core 37 that is fixedly mounted in the vehicle dashboard. As can be appreciated, heater core 37 is adapted to receive heated coolant from engine 21 (e.g., through one or more hoses). Upon receipt of the coolant, external fins on heater core 37 conduct heat. Accordingly, a fan 38 provided in the vehicle dashboard is positioned to selectively blow through the plurality of warmed fins to produce a stream of warmed air that is, in turn, directed into interior vehicle cabin 35 through heating vents provided in the vehicle dashboard.

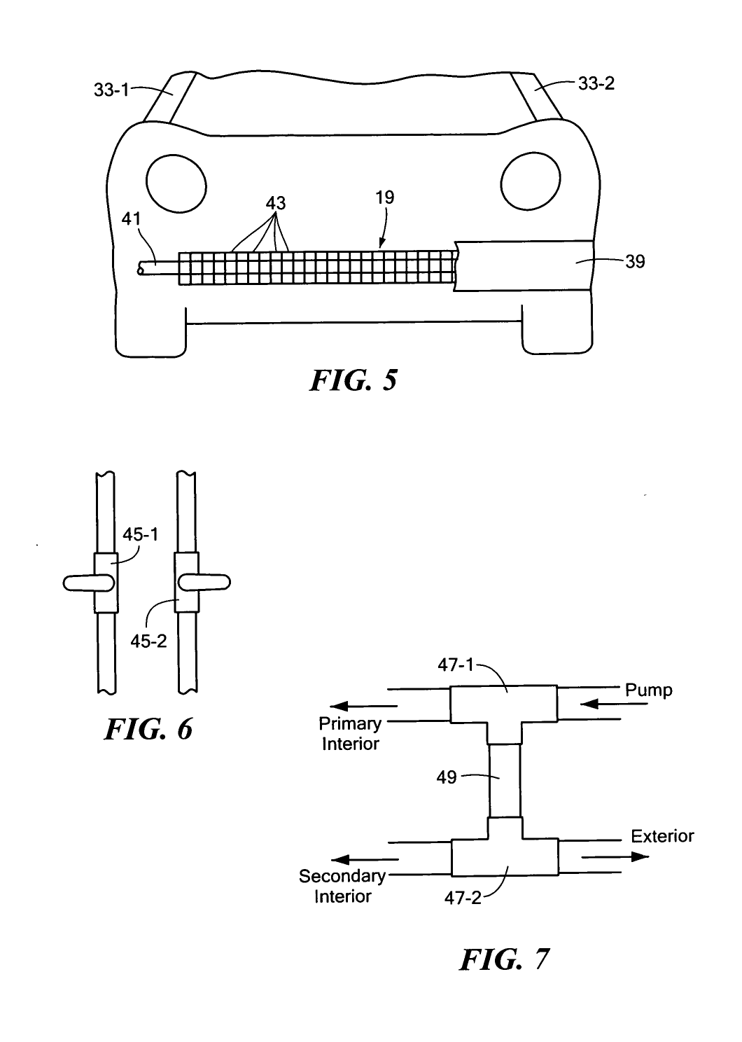

Referring now to FIGS. 1 and 5, exterior heating device 19 is preferably mounted behind the front vehicle bumper 39 and functions, inter alia, to heat the immediate exterior of the vehicle that may otherwise be susceptible to the accumulation of snow, ice or the like. In the present example, exterior heating device 19 is shown mounted behind front vehicle bumper 39. However, it is to be understood that exterior heating device 19 could be alternatively mounted in other similar locations (e.g., under or within front bumper 39 or in close proximity thereto) without departing from the spirit of the present invention.

Exterior heating device 19 comprises an elongated copper pipe 41 on which are mounted a plurality of aluminum fins 43. As can be appreciated, copper pipe 41 is adapted to receive heated coolant from engine 21 (e.g., through the use of one or more fittings, tubings and the like). Upon receipt of the coolant, aluminum fins 43 conduct heat. By virtue of heat-transfer properties, the heat provided by aluminum fins 43 warms the surrounding environment including, but not limited to, the surface on which vehicle 11 is parked. In this capacity, it is to be understood that heating device 19 can be used, inter alia, to warm, and ultimately melt, snow or ice accumulated on the surface, which is highly desirable.

It is to be understood that each of heating devices 15, 17 and 19 can be independently actuated by the operator. In the present example, secondary heating device 17 is preferably operated using conventional electrical controls provided in the vehicle dashboard (e.g., a rotary switch for regulating operation of the fan). Furthermore, it is envisioned that similar controls are preferably provided to allow for the manual regulation of heating devices 15 and 19.

Specifically, referring now to FIG. 6, there is shown a fragmentary front plan view of first and second ball valves 45-1 and 45-2. As can be appreciated, ball valve 45-1 is disposed in the fluid communication path between engine 21 and primary interior heating device 15 and is designed to regulate the flow of coolant therebetween. Similarly, ball valve 45-2 is disposed in the fluid communication path between engine 21 and exterior heating device 19 and is designed to regulate the flow of coolant therebetween. In this manner, by regulating the flow of coolant, ball valves 45-1 and 45-2 serve as manual means for activating/deactivating heating devices 15 and 19, respectively.

It should be noted that heating devices 15, 17 and 19 could be integrated into vehicle 11 by connecting each to a single preexisting water pump for a conventional vehicle cooling system. Specifically, as seen most clearly in FIG. 7, first and second copper tee pipes 47-1 and 47-2 are joined together at their middle connectors by a pipe 49 and are provided to supply heated coolant from engine 13 to heating devices 15, 17 and 19. As shown, first tee pipe 47-1 is connected at one end to the water pump for engine 13. The remaining free ends are connected to pipes for supplying coolant to heating devices 15, 17 and 19. As such, coolant heated by engine 13 is circulated by the water pump to each of devices 15, 17 and 19.

The embodiment of the present invention described above is intended to be merely exemplary and those skilled in the art shall be able to make numerous variations and modifications to them without departing from the spirit of the present invention. All such variations and modifications are intended to be within the scope of the present invention as defined in the appended claims.

What is claimed is:

1. A heating system for an automotive vehicle, the vehicle comprising a frame shaped to define an interior cabin, the vehicle additionally comprising an engine that utilizes a liquid coolant to absorb and transfer excess heat produced therefrom, the heating system comprising:
(a) a length of piping secured to the frame of the vehicle, and
(b) a pair of transport tubes in fluid communication with both the length of piping and the engine,
(c) wherein liquid coolant heated by the engine is transferred away from the engine through one of the transport tubes and circulates within the length of piping to radiantly warm the interior cabin of the automotive vehicle, the other of the transport tubes returning the radiantly cooled liquid coolant circulating within the length of piping back to the engine for reuse.

2. The heating system of claim 1 wherein the length of piping is arranged in a snake-like configuration that includes a plurality of straight parallel sections that are evenly spaced apart.

3. An automotive vehicle comprising:
(a) a frame shaped to define an interior cabin,
(b) an engine for powering the vehicle, the engine utilizing a liquid coolant to absorb and transfer excess heat produced therefrom, and
(c) a heating system for transferring liquid coolant heated by the engine, the heating system comprising a primary heating device coupled to the frame for radiantly warming the interior cabin.

4. The automotive vehicle as claimed in claim 3 wherein the primary heating device comprises:
(a) a length of piping secured to the frame of the vehicle, and
(b) a pair of transport tubes in fluid communication with both the length of piping and the engine,
(c) wherein liquid coolant heated by the engine is transferred away from the engine through one of the transport tubes and circulates within the length of piping to radiantly warm the interior cabin of the automotive vehicle, the other of the transport tubes returning the radiantly cooled liquid coolant circulating within the length of piping back to the engine for reuse.

5. The automotive vehicle as claimed in claim 4 wherein the length of piping is arranged in a snake-like configuration that includes a plurality of straight parallel sections that are evenly spaced apart.

6. The automotive vehicle as claimed in claim 4 further comprising a secondary heating device coupled to the frame for blowing heat into the interior cabin of the automotive vehicle.

7. The automotive vehicle as claimed in claim 6 wherein the secondary heating device comprises:
(a) a heater core coupled to the frame, the heater core being adapted to receive liquid coolant heated by the engine, and
(b) a fan coupled to the frame for blowing air across the heater core and into the interior cabin of the automotive vehicle.

8. The automotive vehicle as claimed in claim 7 wherein each of the primary and secondary heating devices can be independently actuated.

9. The automotive vehicle as claimed in claim 8 wherein each of the primary and secondary heating devices can be independently actuated by regulating the flow of liquid coolant therethrough.

10. The automotive vehicle as claimed in claim 4 further comprising a porous and heat-resistant fabric layer fastened to the frame over the length of piping.

11. The automotive vehicle as claimed in claim 4 further comprising an exterior heating device coupled to the frame for radiantly warming the immediate exterior of the automotive vehicle.
